(19) United States
(12) Patent Application Publication
(10) Pub. No.: US 2025/0110718 A1
(43) Pub. Date: Apr. 3, 2025

(54) ISOLATED TESTING PLATFORM FOR CLOUD DATABASE PRODUCTION QUERIES

(71) Applicant: Snowflake Inc., Bozeman, MT (US)

(72) Inventors: Jin Mo Ahn, Atherton, CA (US); Vlad Bunescu, Morgan Hill, CA (US); Lin Chan, Bellevue, WA (US); Ryan Druckman, Sammamish, WA (US); Adrian Hamza, Sammamish, WA (US); Alexander Hess, Toronto (CA); Gabriel Kliot, Bellevue, WA (US); Albert Nathan McNamara, New York, NY (US); Subramanian Muralidhar, Mercer Island, WA (US); Jiaqi Yan, Menlo Park, CA (US)

(21) Appl. No.: 18/479,589

(22) Filed: Oct. 2, 2023

(51) Int. Cl. G06F 8/60; G06F 11/34

(52) U.S. Cl. CPC G06F 8/60; G06F 11/3495

(57) ABSTRACT

A system and method of isolated testing platform for cloud database production queries. The method includes providing an execution platform including a production deployment to receive a first group of queries from a first group of user devices. The production deployment includes a local data storage to store a first dataset associated with the first group of user devices and an execution node to process the first group of queries based on a first version of an application and based on the user data. The method includes receiving a request to test a second version of the application based on the first version of the application. The method includes deploying a ghost deployment onto the execution platform. The method includes replaying the first group of queries on the ghost deployment using copies of the first version of the application and the second version of the application.

### TECHNICAL FIELD

The present disclosure relates generally to software development, and more particularly, to systems and methods of an isolated testing platform for cloud database production queries.

### BACKGROUND

Data platforms are designed to connect businesses globally across many different workloads and unlock seamless data collaboration. One example of a data platform is a data warehouse, which is an enterprise system used for the analysis and reporting of structured and semi-structured data from multiple sources. Devices may use a data platform for processing and storing data. Devices may use the data platform to perform feature development, which is an iterative and incremental software development process.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram depicting an example embodiment of a new data processing platform 100, according to some embodiments;

FIG. 2 is a block diagram depicting the execution platform of FIG. 1, according to some embodiments. The execution platform 112 includes multiple deployments 202 (e.g., deployments 202a, 202b, 202c), according to some embodiments;

FIG. 3 is a block diagram depicting an example environment for replaying queries, that originated on one or more deployments of an execution platform, on an isolated deployment to perform feature testing of a software application, according to some embodiments;

FIG. 4 is a block diagram depicting an example of the resource manager 102 in FIG. 1 according to some embodiments;

FIG. 5 is a flow diagram depicting a method of replaying queries, that originated on one or more deployments of an execution platform, on an isolated deployment to perform feature testing of a software application, according to some embodiments; and

FIG. 6 is a block diagram of an example computing device that may perform one or more of the operations described herein, in accordance with some embodiments.

### DETAILED DESCRIPTION

A change in software that modifies the existing functionality or adds a new functionality is called a feature. During the development life cycle of software, features are added (or removed) to the software to create a new version of the software and then the software is released into a production environment by installing the software on an execution node of a data platform (e.g., a deployment or cloud computing system) or on an end-user's machine so that the end-user can access the functionality of the software. The particular set of features of the software determine the functionality of the software, including whether the software efficiently executes in the production environment. A newly developed feature undergoes a series of feature testing (e.g., regression testing, unit testing, integration testing, chaos testing) that is designed to quantify and maintain the quality of the software. This type of testing helps to ensure that the newly developed features of the software operate error-free and as expected.

A data platform may perform the feature testing of a software version by using user queries and their corresponding data. The data platform may facilitate constructing a set of queries and then compare their execution on two different deployments—a baseline deployment and a test deployment. That is, the data platform may schedule and execute user queries on these two deployments and compare their results, execution time, and/or resource consumption. The data platform may report the resulting regressions, which indicate where a query produced different results (e.g., as determined by the hash of the results) on the test deployment from the baseline deployment. The data platform may also report the performance regressions, which indicate where a query took notably longer (e.g., exceeding a threshold of 200%) to complete on the test deployment.

However, there are several problems and pain points with feature testing of software using the conventional techniques and data platforms. As an initial matter, from a pre-release perspective, there is a limited amount of time to address errors (e.g., software bugs, defects) found by the feature testing that is performed on the data platform. For example, a data platform that only supports running a limited version delta of releases concurrently cannot deploy upcoming versions to a production environment until they are about to be released to the users of the data platform. In some instances, this constraint stems from requirements for some data platforms to support compatibility for a limited number of versions of a particular software by only supporting backward compatibility for the previous version (e.g., version −1) and forward compatibility for the next version (e.g., version +1) of the software. The goal of this limited version compatibility is to increase developer productivity, but because the software version (along with its features) is released to a deployment of the data platform for testing, the limited version compatibility can restrict when and/or how the deployment tests the new and/or modified features of the software.

Furthermore, the data platform might not have the means to test multiple software versions in the same deployment without risking user data (e.g., including metadata) corruption. This limitation also puts pressure on the software release process, leaving only a short window during which the software version can safely be tested before making it available to users. It also limits how developers are able to test and verify the effects of new software releases.

The delay in identifying and resolving the errors with the software version that is currently accessible by the users of the data platform can expose the data platform to significant vulnerabilities that can degrade the performance of the data platform. For one, the defective software could force the data platform to consume excess processing resources, memory resources, storage resources, display resources, and/or networking resources of the data platform to execute the defective software. Moreover, the defective feature could cause software (e.g., health insurance software, financial software, etc.) to make miscalculations that could negatively impact the lives of the people in society who rely on the decisions made by software.

Thus, there is a long-felt but unsolved need to solve the problems of improving the feature testing of software in a production environment without degrading the resources and data of the production environment.

Aspects of the present disclosure address the above-noted and other deficiencies by creating, in an execution platform (e.g., data platform) that processes queries for user devices, a specific deployment (sometimes referred to as an isolated deployment, a ghost deployment, or ghost shard) whose resources are isolated from the resources of other deployments (sometimes referred to as production shards) of the execution platform to perform feature testing of software versions using the user queries, but without corrupting the user data associated with the user queries.

The present disclosure provides a ghost deployment that simultaneously executes on an execution platform, along-side other deployments of the execution platform. The ghost deployment is a dedicated infrastructure of computing resources (e.g., memory, processor, and/or data storage, etc.) on which a resource manager of the execution platform can deploy software applications (e.g., binaries) and perform feature testing of the software applications without adversely impacting user data or workloads. Like any other deployment of the execution platform, a ghost deployment can read data from its siblings (e.g., the other deployments). However, an essential property that distinguishes a ghost deployment from the other deployments, such as those that are deployed into a production environment and used by users of the data platform, is that the ghost deployment cannot write to, and cannot be seen from, these production deployments. The ghost deployment can also replay a query from another deployment in the same shared group. Thus, a ghost deployment provides an isolated environment for performing feature testing of software applications, thereby allowing software developers to test release software applications by replaying user queries and using user data, but without risk of corrupting the user data that is locally stored in the production deployments and/or in remote storage locations.

Benefits of the embodiments of the present disclosure may include no longer having to push new versions of the software applications to each production deployment of the execution platform before testing the software version because there is now a dedicated deployment for doing so. Also, because the sharding, which is the act of creating a ghost shard or ghost deployment, provides protection against metadata writes, a software developer now has a way to test the new binaries without risk of causing corruption to user data (including metadata) in the production environment. Thirdly, the aforementioned features of the ghost deployment also provide a developer with total freedom to decide when to perform feature testing of a new binary, thereby giving the developer the opportunity to find and resolve errors/bugs much earlier. This also provides a safe, isolated sandbox deployment that developers across the data platform can use, which prevents testing and investigation that would otherwise happen in, and risk affecting, the production deployments.

Thus, by having an isolated testing environment, the developer can accelerate and expand the scope and pace of testing and feature development. The developer will be able to take advantage of powerful feature testing tools much sooner, which minimizes release delays and development cycle time and without putting metadata safety at risk. The ghost development accelerates the release qualification workflow and lays the groundwork for future opportunities to make other workflows safer and more reliable as well.

In an illustrative embodiment, a resource manager is communicatively coupled to an execution platform that includes a production deployment (e.g., data store) to receive a first group of queries from a first group of user devices. The production deployment includes a local data storage to store a first dataset associated with the first group of user devices and an execution node to process the first group of queries based on a first version of an application executing on the execution node and based on the first dataset stored in the local data storage. The resource manager receives a request to test a second version of the application based on the first version of the application. The resource manager deploys a ghost deployment onto the execution platform, where the ghost deployment has read-only access (but not write privilege) to the first dataset stored in the local data storage of the production deployment. In some embodiments, a developer (instead of the resource manager) using a computer may deploy the ghost deployment onto the execution platform. The resource manager replays, based on the first dataset, the first group of queries on the ghost deployment using copies of the first version of the application and the second version of the application without altering the first dataset stored in the local data storage to generate comparison data.

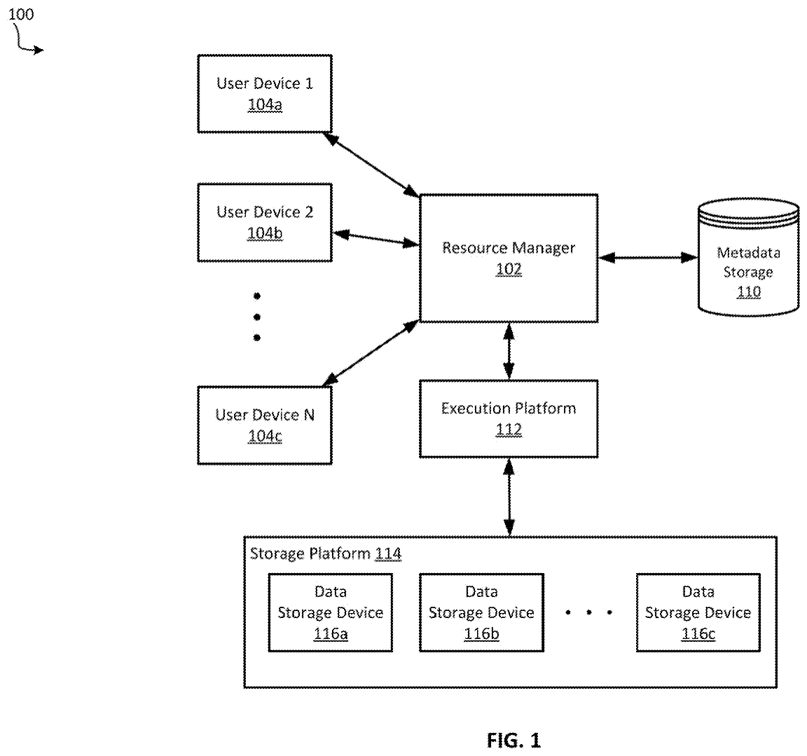

FIG. 1 is a block diagram depicting an example embodiment of a new data processing platform 100, according to some embodiments. As shown in FIG. 1, a resource manager 102 is coupled to multiple user devices 104 (e.g., user devices 104a, 104b, 104c, etc.). In particular implementations, resource manager 102 can support any number of user devices desiring access to data processing platform 100. User device 104 may include, for example, end user device providing data storage and retrieval requests, system administrators managing the systems and methods described herein, and other components/devices that interact with resource manager 102. The user device may be operated by a user of the data processing platform 100. Resource manager 102 provides various services and functions that support the operation of all systems and components within data processing platform 100. As used herein, resource manager 102 may also be referred to as a “dynamic warehouse manager” that performs various functions as discussed herein.

Resource manager 102 is also coupled to a data storage (e.g., metadata storage 110) that stores metadata that is associated with the entirety of data stored throughout data processing platform 100. In some embodiments, metadata storage 110 includes metadata that includes a summary of data stored in remote data storage systems as well as data available from a local cache. Additionally, the metadata may include information regarding how data is organized in the remote data storage systems and the local caches. The metadata allows systems and services to determine whether a piece of data needs to be accessed without loading or accessing the actual data from a storage device.

The metadata also includes information indicating which queries were executed on which execution nodes of the execution platform 112. The information also indicates the particular version of the application that was used to process the query and identifiers to the one or more datasets that were used by the application to process the query. For example, the identifier may be a storage pointer (e.g., network path) that references a storage location (e.g., a local storage, a data storage device 116 of the storage platform 114, etc.) containing the one or more datasets associated with the query.

Resource manager 102 is further coupled to an execution platform 112, which provides multiple computing resources that execute various data storage and data retrieval tasks, as discussed in greater detail below. Execution platform 112 is coupled to multiple data storage devices 116 (e.g., data storage device 116a, data storage device 116b, data storage device 116c, etc.) that are part of a storage platform 114. In some embodiments, the data storage devices 116 are cloud-based storage devices located in one or more geographic locations. For example, data storage devices 116 may be part of a public cloud infrastructure or a private cloud infrastructure. Data storage devices 116 may be hard disk drives (HDDs), solid state drives (SSDs), storage clusters, Amazon S3™ storage systems or any other data storage technology. Additionally, storage platform 114 may include distributed file systems (e.g., Hadoop Distributed File Systems (HDFS)), object storage systems, and/or the like.

In particular embodiments, the communication links between resource manager 102 and user devices 104, metadata storage 110, and execution platform 112 are implemented via one or more data communication networks. Similarly, the communication links between execution platform 112 and data storage devices 116 in storage platform 114 are implemented via one or more data communication networks. These data communication networks may utilize any communication protocol and any type of communication medium. In some embodiments, the data communication networks are a combination of two or more data communication networks (or sub-networks) coupled to one another. In alternate embodiments, these communication links are implemented using any type of communication medium and any communication protocol.

As shown in FIG. 1, data storage devices 116 are decoupled from the computing resources associated with execution platform 112. This architecture supports dynamic changes to data processing platform 100 based on the changing data storage/retrieval needs as well as the changing needs of the users and systems accessing data processing platform 100. The support of dynamic changes allows data processing platform 100 to scale quickly in response to changing demands on the systems and components within data processing platform 100. The decoupling of the computing resources from the data storage devices supports the storage of large amounts of data without requiring a corresponding large amount of computing resources. Similarly, this decoupling of resources supports a significant increase in the computing resources utilized at a particular time without requiring a corresponding increase in the available data storage resources.

Resource manager 102, metadata storage 110, execution platform 112, and storage platform 114 are shown in FIG. 1 as individual components. However, each of resource manager 102, metadata storage 110, execution platform 112, and storage platform 114 may be implemented as a distributed system (e.g., distributed across multiple systems/platforms at multiple geographic locations). Additionally, each of resource manager 102, metadata storage 110, execution platform 112, and storage platform 114 can be scaled up or down (independently of one another) depending on changes to the requests received from user devices 104 and the changing needs of data processing platform 100. Thus, in the described embodiments, data processing platform 100 is dynamic and supports regular changes to meet the current data processing needs.

During operation, data processing platform 100 processes multiple queries (or requests) received from any of the user devices 104. These queries are managed by resource manager 102 to determine when and how to execute the queries. For example, resource manager 102 may determine what data is needed to process the query and further determine which nodes within execution platform 112 are best suited to process the query. Some nodes may have already cached the data needed to process the query and, therefore, are good candidates for processing the query. The metadata in the metadata storage 110 assists the resource manager 102 in determining which nodes in execution platform 112 already cache at least a portion of the data needed to process the query. One or more nodes in execution platform 112 process the query using data cached by the nodes and, if necessary, data retrieved from storage platform 114. In some embodiments, it is desirable to retrieve as much data as possible from caches within execution platform 112 because the retrieval speed is typically much faster than retrieving data from storage platform 114.

The metadata in the metadata storage 110 also assists the resource manager 102 in determining which queries (and corresponding data) were executed on which execution nodes of the execution platform 112, and which version of an application executing on the execution node was used to process the query. The metadata in the metadata storage 110 also assists the resource manager 102 in determining which datasets were used by the application to process the query.

The metadata also includes information indicating which queries were executed on which execution nodes of the execution platform 112. The information also indicates the particular version of the application that was used to process the query and identifiers to the one or more datasets that were used by the application to process the query. For example, the identifier may be a storage pointer (e.g., network path) that references a storage location (e.g., a local storage, a data storage device 116 of the storage platform 114, etc.) containing the one or more datasets associated with the query.

As shown in FIG. 1, data processing platform 100 separates execution platform 112 from storage platform 114. In this arrangement, the processing resources and cache resources in execution platform 112 operate independently of the data storage resources 116 in storage platform 114. Thus, the computing resources and cache resources are not restricted to specific data storage resources 116. Instead, all computing resources and all cache resources may retrieve data from, and store data to, any of the data storage resources in storage platform 114. Additionally, data processing platform 100 supports the addition of new computing resources and cache resources to execution platform 112 without requiring any changes to storage platform 114. Similarly, data processing platform 100 supports the addition of data storage resources to storage platform 114 without requiring any changes to nodes in execution platform 112.

Although FIG. 1 shows only a select number of computing devices (e.g., user device 104, resource manager 102), execution platforms (e.g., execution platform 112), and storage platforms (storage platform 114); the environment 100 may include any number of computing devices, execution platforms, and/or storage platforms that are interconnected in any arrangement to facilitate the exchange of data between the computing devices and the platforms. For example, the resource manager 102 may be coupled to multiple execution platforms 112. Additionally, the storage platform 114 may include any number of data storage devices 116a.

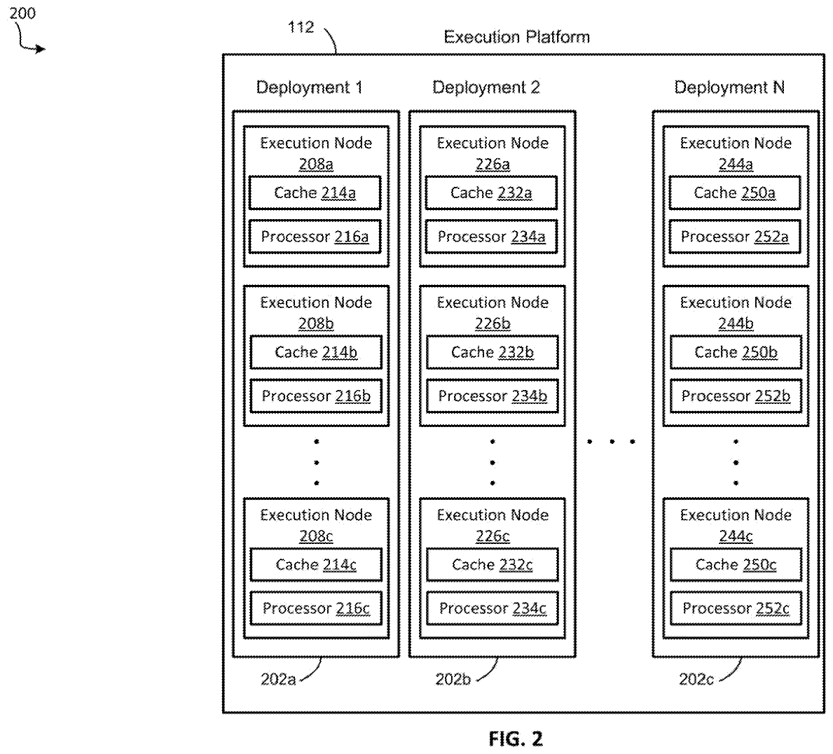

FIG. 2 is a block diagram depicting the execution platform of FIG. 1, according to some embodiments. The execution platform 112 includes multiple deployments 202 (e.g., deployments 202a, 202b, 202c), according to some embodiments. Each deployment 202 (sometimes referred to as a Global Services (GS) layer) includes multiple execution nodes that each include a data cache and a processor. Specifically, deployment 202a includes execution nodes 208 (e.g., execution nodes 208a, 208b, 208c), cache 214 (e.g., cache 214a, 214b, 214c), and processors 216 (e.g., processor 216a, 216b, 216c); deployment 202b includes execution nodes 226 (e.g., execution nodes 226a, 226b, 226c), cache 232 (e.g., cache 232a, 232b, 232c), and processors 234 (e.g., processor 234a, 234b, 234c); and deployment 202c includes execution nodes 244 (e.g., execution nodes 244a, 244b, 244c), cache 250 (e.g., cache 250a, 250b, 250c), and processors 252 (e.g., processor 252a, 252b, 252c). In some embodiments, an execution node may be a central processing unit (CPU).

Each execution node includes a cache and a processor. Specifically, with regard to deployment 202a, execution node 208a includes cache 214a and processor 216a; execution node 208b includes cache 214b and processor 216b; execution node 208c includes cache 214c and processor 216c. With regard to deployment 202b, execution node 226a includes cache 232a and processor 234a; execution node 226b includes cache 232b and processor 234b; execution node 226c includes cache 232c and processor 234c. With regard to deployment 202c, execution node 244a includes cache 250a and processor 252a; execution node 244b includes cache 250b and processor 252b; execution node 244c includes cache 250c and processor 252c.

Each of the execution nodes 208, 226, 244 is associated with processing one or more data storage and/or data retrieval tasks. For example, a particular deployment may handle data storage and data retrieval tasks associated with a particular user. In other implementations, a particular deployment may handle data storage and data retrieval tasks associated with a particular data storage system or a particular category of data.

Deployments 202 are capable of executing multiple queries (and other tasks) in parallel by using the multiple execution nodes. As discussed herein, execution platform 112 can add new deployments and drop existing deployments in real time based on the current processing needs of the systems and users. This flexibility allows execution platform 112 to quickly deploy large amounts of computing resources when needed without being forced to continue paying for those computing resources when they are no longer needed. All deployments can access data from any data storage device (e.g., any storage device in storage platform 114 in FIG. 1).

A deployment may be any type of system used for the processing and reporting of structured and semi-structured data from multiple sources, including for example, one or more database servers, a data warehouse, a virtual warehouse, a datastore, a data lake, a data pond, a data mesh, and/or the like.

Although each deployment 202 shown in FIG. 2 includes three execution nodes, a particular deployment may include any number of execution nodes. Further, the number of execution nodes in a deployment is dynamic, such that new execution nodes are created when additional demand is present, and existing execution nodes are deleted when they are no longer necessary.

Each deployment 202 is capable of accessing any of the data storage devices 116 shown in FIG. 1. Thus, deployments 202 are not necessarily assigned to a specific data storage device 116 and, instead, can access data from any of the data storage devices 116. Similarly, each of the execution nodes shown in FIG. 2 can access data from any of the data storage devices 116. In some embodiments, a particular deployment or a particular execution node may be temporarily assigned to a specific data storage device, but the deployment or execution node may later access data from any other data storage device.

In some embodiments, the execution nodes shown in FIG. 2 are stateless with respect to the data the execution nodes are caching. For example, these execution nodes do not store or otherwise maintain state information about the execution node or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 2 each include one data cache and one processor, alternate embodiments may include execution nodes containing any number of processors and any number of caches. Additionally, the caches may vary in size among the different execution nodes. The caches shown in FIG. 2 store, in the local execution node, data that was retrieved from one or more data storage devices in storage platform 114 in FIG. 1. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes which is significantly faster and avoids the bottleneck problem discussed above. In some embodiments, the caches are implemented using high-speed memory devices that provide fast access to the cached data. Each cache can store data from any of the storage devices in storage platform 114.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some embodiments, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, a particular execution node may be assigned more processing resources if the tasks performed by the execution node become more processor intensive. Similarly, an execution node may be assigned more cache resources if the tasks performed by the execution node require a larger cache capacity.

Although deployments 202 are associated with the same execution platform 112, the deployments 202 may be implemented using multiple computing systems at multiple geographic locations. For example, deployment 202a can be implemented by a computing system at a first geographic location, while deployments 202b and 202c are implemented by another computing system at a second geographic location. In some embodiments, these different computing systems are cloud-based computing systems maintained by one or more different entities.

Additionally, each deployment 202 is shown in FIG. 2 as having multiple execution nodes. The multiple execution nodes associated with each deployment 202 may be implemented using multiple computing systems at multiple geographic locations. For example, a particular instance of deployment 202 implements execution nodes 208a-208c on one computing platform at a particular geographic location and implements execution nodes 208d-208f at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the deployment.

Execution platform 112 is also fault tolerant. For example, if one deployment 202 fails, that deployment 202 is quickly replaced with a different deployment 202 at a different geographic location.

A particular execution platform 112 may include any number of deployments 202. Additionally, the number of deployments 202 in a particular execution platform 112 is dynamic, such that new deployments 202 are created when additional processing and/or caching resources are needed. Similarly, existing deployments 202 may be deleted when the resources associated with the deployment 202 are no longer necessary.

In some embodiments, each of the deployments 202 may operate on the same data in storage platform 114, but each deployment 202 has its own execution nodes with independent processing and caching resources. This configuration allows requests on different deployments 202 to be processed independently and with no interference between the requests. This independent processing, combined with the ability to dynamically add and remove deployments 202, supports the addition of new processing capacity for new users without impacting the performance observed by the existing users.

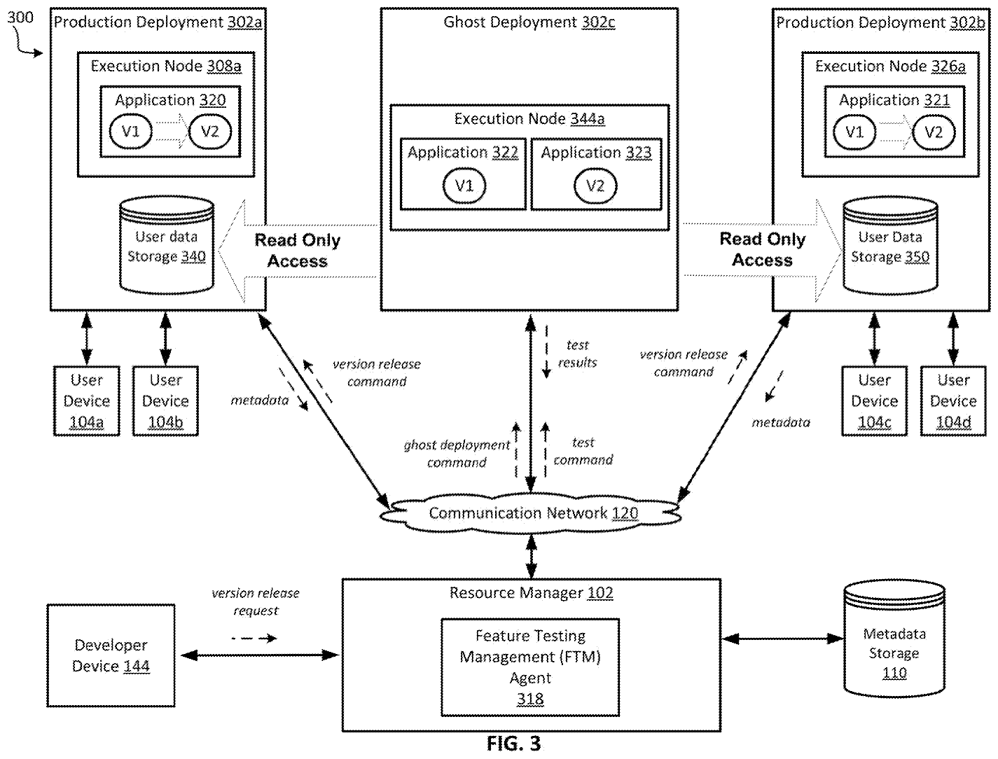

FIG. 3 is a block diagram depicting an example environment for replaying queries that originated on one or more deployments of an execution platform, on an isolated deployment to perform feature testing of a software application, according to some embodiments. The environment 400 includes a resource manager 102, a production deployment 302a, a production deployment 302b, a ghost deployment 302c, a developer device 144, and metadata storage 110 that are each communicatively coupled together via a communication network 120. The production deployment 302a is communicatively coupled to user device 104a, 104b and the production deployment 302b is communicatively coupled to user device 104b, 104c.

The production deployment 302a includes a user data storage 340 to store user data associated with user device 104a, 104b, and an execution node 308 to execute a first version of an application 320 using the user data. The production deployment 302 receives queries from the user devices 104a, 104b and processes the queries using the first version of an application 320 and any user data indicated in the queries. Likewise, the production deployment 302b includes a user data storage 350 to store user data associated with user device 104c, 104d, and an execution node 326 to execute the first version of an application 321 using the user data. The application 321 and the application 320 may be copies of one another. The production deployment 302b receives queries from the user devices 104c, 104d and processes the queries using the first version of an application 321 and any user data indicated in the queries.

The resource manager 102 generates the production deployment 302a by configuring deployment 202a in FIG. 2 as a production deployment and the deployment 202b as a production deployment in FIG. 2. The resource manager 102 generates the ghost deployment 302c by configuring deployment 202c as a ghost deployment instead of a production deployment. Alternatively, a developer (instead of the resource manager 102) may use the developer device 144 to generate the ghost deployment 302c by configuring the production deployment 202c as a ghost deployment. In some embodiments, the resource manager 102 (or the developer device 144) may generate a ghost deployment 302c and deploy the ghost deployment 302c onto the execution platform 112 without first deploying the ghost deployment 302c as a production deployment and reconfiguring the production deployment as the ghost deployment 302c.

The production deployments 302a, 302b are visible to one another, including any other production deployments in the execution platform 112. As a result, the production deployments 302a, 302b can communicate with each other and/or access one another's locally stored data. Conversely, the ghost deployment 302c is not visible to the production deployments 302a, 302b, and thus the production deployments 302a, 302b cannot communicate with the ghost deployment 302c or access the data stored on the ghost deployment 302c. Furthermore, the resource manager 102 configures the ghost deployment 302c to have read-only access to any data stored on the production deployments 302a, 302b, thereby allowing the ghost deployment 302c to process the data of the production deployments 302a, 302b in a way that does not alter the data as stored on the production deployments 302a, 302b. The resource manager 102 also allocates, for the ghost deployment 302c, a set of resources (e.g., execution node, memory, etc.) that are isolated from the resources used by the production deployments 302a, 302b to ensure that the ghost deployment 302c does not negatively interfere with the performance of the production deployments 302a, 302b.

The resource manager 102 receives a request from the developer device 144 to test and/or release a second version of an application based on a first version of the application. To test the second version of the application, the resource manager 102 replays (e.g., re-process, re-run, re-execute) queries on the ghost deployment 302c to determine whether there is a performance difference or result difference between the two versions of the application. The resource manager determines, based on the metadata stored in the metadata storage 110, that the production deployment 302a previously processed a first query on its execution node 308a using a first version of the application 320 and a first dataset associated with the user device 104a and/or user device 104b. In response, the resource manager 102 sends a test command to install a copy (shown in FIG. 3 as application 322) of the first version of the application 320 onto the execution node 344a of the ghost deployment 302c and a copy (shown in FIG. 3 as application 323) of the second version of the application 320 onto the execution node 344a of the ghost deployment 302c. The test command also causes the ghost deployment 302c to read the first dataset from the user data storage 340 of the production deployment 302a, but without altering (e.g., modifying, changing, corrupting) the first dataset as stored in the user data storage 340. The ghost deployment 302c generates a baseline result by processing the first query and the first dataset using the copy of the first version of the application 320 on the ghost deployment 302c, where the baseline results indicate a performance of the first version of the application 320. The ghost deployment 302c also generates a target result by processing the first query and the first dataset using the copy of the second version of the application 320, where the target results indicate a performance of the second version of the application 320. The ghost deployment 302c sends the baseline results and the target results to the resource manager 102, so that the resource manager 102 can compare the baseline results and the target results and generate the comparison results.

The resource manager 102 compares the baseline results and the target results to determine whether the second version of the application 320 performs differently than the first version of the application 320. If the FTM agent 318 determines, based on the comparison data, that a performance of the second version of the application 320 is less (or worse than) than a performance of the first version of the application 320, then the FTM agent 318 implements and/or executes a remedial action, such as preventing the second version of the application 320 from being installed on the production deployment 302a and/or the production deployment 302b.

The systems, methods, and devices discussed herein may be implemented with cloud-based database technology. That is, the resource manager may store database data (e.g., user data, user queries) in a cloud based storage that is accessible across geographic regions. A cloud-based storage may, for example, refer to database data that is stored at an off-site storage system that may be maintained by a third party in some implementations. For example, a user may elect to store data with a cloud storage provider rather than storing the data on a local computer hard drive or other local storage device owned by the user. The user may access the data by way of an Internet connection between the user's computing resources and the off-site storage resources that are storing the client's user.

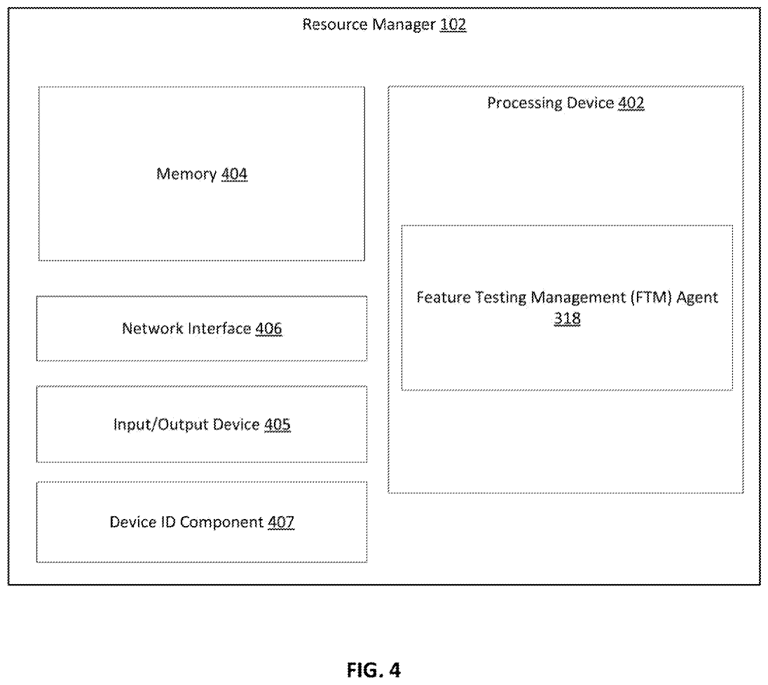

FIG. 4 is a block diagram depicting an example of the resource manager 102 in FIG. 1 according to some embodiments. While various devices, interfaces, and logic with particular functionality are shown, it should be understood that the resource manager 102 includes any number of devices and/or components, interfaces, and logic for facilitating the functions described herein. For example, the activities of multiple devices may be combined as a single device and implemented on a same processing device (e.g., processing device 402), as additional devices and/or components with additional functionality are included.

The resource manager 102 includes a processing device 402 (e.g., general purpose processor, a PLD, etc.), which may be composed of one or more processors, and a memory 404 (e.g., synchronous dynamic random-access memory (DRAM), read-only memory (ROM)), which may communicate with each other via a bus (not shown).

The processing device 402 may be provided by one or more general-purpose processing devices such as a microprocessor, central processing unit, or the like. In some embodiments, processing device 402 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. In some embodiments, the processing device 402 may include one or more special-purpose processing devices such as an application specific integrated circuit (ASIC), a field programmable gate array (FPGA), a digital signal processor (DSP), network processor, or the like. The processing device 402 may be configured to execute the operations described herein, in accordance with one or more aspects of the present disclosure, for performing the operations and steps discussed herein.

The memory 404 (e.g., Random Access Memory (RAM), Read-Only Memory (ROM), Non-volatile RAM (NVRAM), Flash Memory, hard disk storage, optical media, etc.) of processing device 402 stores data and/or computer instructions/code for facilitating at least some of the various processes described herein. The memory 404 includes tangible, non-transient volatile memory, or non-volatile memory. The memory 404 stores programming logic (e.g., instructions/code) that, when executed by the processing device 402, controls the operations of the resource manager 102. In some embodiments, the processing device 402 and the memory 404 form various processing devices and/or circuits described with respect to the resource manager 102. The instructions include code from any suitable computer programming language such as, but not limited to, C, C++, C#, Java, JavaScript, VBScript, Perl, HTML, XML, Python, TCL, Scala, and Basic.

The processing device 402 may include and/or execute a feature testing management (FTM) agent 318 that may be configured to generate the execution platform 112 in FIG. 2. The FTM agent 318 configures (or defines) each of the deployments 202 of the execution platform 112 as production deployments, such that each of the deployments 202 are visible to the other deployments 202. For example, the FTM agent 318 generates the production deployment 302a by configuring deployment 202a as a production deployment and the production deployment 302b by configuring deployment 202b as a production deployment. A first deployment is visible to a second deployment in the execution platform 112 if the second deployment knows about the existence of the first deployment in the execution platform 112.

The FTM agent 318 configures the production deployment 302a to receive a first group of queries from a first group of user devices 104 (e.g., user devices 104a, 104b). The production deployment 202a includes the user storage 340 to store a first dataset (e.g., user data) that is associated with the first group of user devices 104 and an execution node (e.g., execution node 208a) to process the first group of queries based on a first version of the application 320 executing on the execution node and based on the user data stored in the user storage 340.

The FTM agent 318 may be configured to receive a request to test a second version of the application 320 based on the first version of the application 320.

The FTM agent 318 may be configured to deploy a ghost deployment 302c (e.g., an isolated deployment) onto the execution platform 112. For example, the FTM agent 318 may deploy the ghost deployment 302c by configuring deployment 202c as a ghost deployment. The FTM agent 318 configures the ghost deployment 302c to have read-only access to the first dataset stored in the user storage 340 of the production deployment 302a. The FTM agent 318 allocates, for the ghost deployment 302c, a set of resources (e.g., execution node, memory, etc.) that are isolated from the resources used by the production deployments 302a, 302b of the execution platform to ensure that the ghost deployment 302c does not negatively interfere with the performance of the production deployments 302a, 302b.

While the ghost deployment 202c is deployed with deployment automation like a normal production deployment, there are key differences between the ghost deployment 302c and the production deployment 302a, 302b. First, the FTM agent 318 configures the sizes of the different services (e.g., clusters) of the ghost deployment 302c to be smaller than each of the service sizes of the production deployments 302a, 302b. Second, the FTM agent 318 sets up sharding on the ghost deployment 302c, but not on the production deployments 302a, 302b. This means that the production deployments 302a, 302b are unaware of the existence of the ghost deployment 302c because the ghost deployment 302c is not visible to the production deployments 302a, 302b, and thus cannot communicate with the ghost deployment 302c or access data stored on the ghost deployment 302c. This also eliminates the need to configure or modify the production deployments 302a, 302b and ensures they will not accidentally try to access the ghost deployment 302c. Finally, the FTM agent 318 configures the ghost deployment 302c to be unable to accept user accounts, such that the ghost deployment 302c cannot communicate with user devices 104a-104d.

The FTM agent 318 may be configured to configure the ghost deployment 302c as a “self-meshed” deployment in terms of the replication mesh. In other words, this means that the ghost deployment 302c is not connected via a communication channel (e.g., global messaging) to the production deployments 302a, 302b. This prevents release drift (especially during a release freeze) from being introduced into the execution platform 112 that could potentially result in corruption. This also ensures that there is sufficient isolation between the resources (e.g., computing, memory, storage, networking, etc.) of the ghost deployment 302c and the resources of the production deployments 302a, 302b; otherwise, there is no mechanism to prevent cross-deployment features from being used in the ghost deployment 302c, which could negatively impact a performance of the production deployments 302a, 302b.

The FTM agent 318 may be configured to acquire metadata associated with the production deployment 302a, 302b. For example, each production deployment 302 may generate its own metadata that includes information indicating which queries were executed on its execution nodes and send the metadata to the resource manager 102, which in turn, stores the metadata in the metadata storage 110. The information in the metadata also indicates the particular version of the application that the execution node used to process the query and identifiers to the one or more datasets that were used by the application to process the query. For example, the identifier may be a storage pointer (e.g., network path) that references a storage location (e.g., user data storage 340, user data storage 350) containing the one or more datasets associated with the query.

The FTM agent 318 may be configured to replay (e.g., re-process, re-run) the first group of queries on the ghost deployment 302c using multiple versions of the application 320 to generate comparison data. For example, the FTM agent 318 determines, based on the metadata storage 110, that the production deployment 302a previously processed a first query on its execution node using a first version of the application 320 and a first dataset associated with the user device 104a and/or user device 104b. In response, the FTM agent 318 sends a test command to install a copy (shown in FIG. 3 as application 322) of the first version of the application 320 onto the execution node of the ghost deployment 302c and a copy (shown in FIG. 3 as application 323) of the second version of the application 320 onto the execution node of the ghost deployment 302c. The test command also causes the ghost deployment 302c to read the first dataset from the user data storage 340 of the production deployment 302a, but without altering (e.g., modifying, changing, corrupting) the first dataset as stored in the user data storage 340. The ghost deployment 302c generates a baseline result by processing the first query and the first dataset using the copy of the first version of the application 320 on the ghost deployment 302c, where the baseline results indicate a performance of the first version of the application 320. The ghost deployment 302c also generates a target result by processing the first query and the first dataset using the copy of the second version of the application 320, where the target results indicate a performance of the second version of the application 320. The ghost deployment 302c sends the baseline results and the target results to the resource manager 102, so that the FTM agent 318 can compare the baseline results and the target results and generate the comparison results.

The FTM agent 318 compares the baseline results and the target results to determine whether the second version of the application 320 performs differently than the first version of the application 320. For example, the FTM agent 318 may determine that the second version of the application 320 performs differently if the second version of the applications 320 includes more software bugs than the first version of the application 320, the bugs of the second version of the application 320 are more severe (e.g., cause greater harm to the computing resources, waste more resources, cause the production deployment 302a to consume more power), and/or causes the production deployment 302 to perform more slowly as compared to its performance when executing the first version of the application 320.

If the FTM agent 318 determines, based on the comparison data, that a performance of the second version of the application 320 is less (or worse than) than a performance of the first version of the application 320, then the FTM agent 318 implements and/or executes a remedial action. In some embodiments, the remedial action may be that the FTM agent 318 prevents a copy of the second version of the application 320 from being installed on the production deployment 302a. The FTM agent 318 may prevent the copy of the second version of the application 320 from being installed on the production deployment 302a by deciding to not install the second version of the application 320 on the production deployment 302a or any other production deployments (e.g., production deployment 302b) in the execution platform 112. The FTM agent 318 may also prevent the copy of the second version of the application 320 from being installed on the production deployment 302a by informing the production deployment 302a to reject any attempts by other computing devices to install the second version of the application 320 on the production deployment 302a.

In some embodiments, the remedial action may be that the FTM agent 318 may modify the second version of the application 320 based on the performance differences to generate a modified second version of the application 320. The FTM agent 318 deploys the modified second version of the application 320 into the execution platform 312 to cause the modified second version of the application 320 to be installed on the production deployment 302a.

If the FTM agent 318 determines, based on the comparison data, that a performance of the second version of the application 320 is greater (or better than) than a performance of the first version of the application 320, then the FTM agent 318 deploys the second version of the application 320 into the execution platform 312 to cause the second version of the application 320 to be installed on the production deployment 302a.

In some embodiments, the FTM agent 318 may be configured to determine whether to implement and/or execute a remedial action based on multiple queries from multiple production deployments 302, where the multiple queries are associated with multiple datasets. For example, the FTM agent 318 replays a second query on the ghost deployment 302c using the copies of the first version of the application 320 and the second version of the application 320 using a second dataset associated with the user device 104c and/or user device 104d, where the production deployment 302b previously processed the second query on its execution node using the first version of the application 320 and the second dataset associated with the user device 104a and/or user device 104b. The replaying of the second query on the ghost deployment 302c and the second dataset does not alter the second dataset as stored in the user data storage 350 of the production deployment 302b. The FTM agent 318 may then determine, based on the comparison data, that the performance of the second version of the application is also less than the performance of the first version of the application when processing the second query and the second dataset. Thus, the FTM agent 318 may be configured to determine whether to implement and/or execute a remedial action based on both the comparison data and the second comparison data.

The resource manager 102 (specifically, the FTM agent 318) may use result obfuscation in instances where data and/or code security is important. In certain instances, and for certain database data or database users, it can be imperative to ensure that database data and query results are secure. Therefore, the resource manager 102 may implement result obfuscation to ensure that rerunning a user query does not reveal the user's data. For example, the FTM agent 318 may generate and add hash aggregation operators to a query plan, for example, to a top of the query plan. The FTM agent 318 may configure these hash aggregation operators to reduce the results of obfuscated queries to one single hash value and guarantee that the developer device 112 will not be able to see the results returned by a user query. The FTM agent 318 may use a hash function to compute a stable hash aggregation that ensures that the results are comparable for different runs of the same user query. The stable hash aggregation may ensure that the developer device 112 has visibility only into whether the rerun user query result is the same as the original query result, and that the developer device 112 does not have any visibility into the actual values of the query result.

The resource manager 102 includes a network interface 406 configured to establish a communication session with a computing device for sending and receiving data over the communication network 120 to the computing device. Accordingly, the network interface 406 includes a cellular transceiver (supporting cellular standards), a local wireless network transceiver (supporting 802.11X, ZigBee, Bluetooth, Wi-Fi, or the like), a wired network interface, a combination thereof (e.g., both a cellular transceiver and a Bluetooth transceiver), and/or the like. In some embodiments, the resource manager 102 includes a plurality of network interfaces 406 of different types, allowing for connections to a variety of networks, such as local area networks (public or private) or wide area networks including the Internet, via different sub-networks.

The resource manager 102 includes an input/output device 405 configured to receive user input from and provide information to a user. In this regard, the input/output device 405 is structured to exchange data, communications, instructions, etc. with an input/output component of the resource manager 102. Accordingly, input/output device 405 may be any electronic device that conveys data to a user by generating sensory information (e.g., a visualization on a display, one or more sounds, tactile feedback, etc.) and/or converts received sensory information from a user into electronic signals (e.g., a keyboard, a mouse, a pointing device, a touch screen display, a microphone, etc.). The one or more user interfaces may be internal to the housing of resource manager 102, such as a built-in display, touch screen, microphone, etc., or external to the housing of resource manager 102, such as a monitor connected to resource manager 102, a speaker connected to resource manager 102, etc., according to various embodiments. In some embodiments, the resource manager 102 includes communication circuitry for facilitating the exchange of data, values, messages, and the like between the input/output device 405 and the components of the resource manager 102. In some embodiments, the input/output device 405 includes machine-readable media for facilitating the exchange of information between the input/output device 405 and the components of the resource manager 102. In still another embodiment, the input/output device 405 includes any combination of hardware components (e.g., a touchscreen), communication circuitry, and machine-readable media.

The resource manager 102 includes a device identification component 407 (shown in FIG. 4 as device ID component 407) configured to generate and/or manage a device identifier associated with the resource manager 102. The device identifier may include any type and form of identification used to distinguish the resource manager 102 from other computing devices. In some embodiments, to preserve privacy, the device identifier may be cryptographically generated, encrypted, or otherwise obfuscated by any device and/or component of resource manager 102. In some embodiments, the resource manager 102 may include the device identifier in any communication (e.g., ghost deployment command, test command, version release command, etc.) that the resource manager 102 sends to a computing device.

The resource manager 102 includes a bus (not shown), such as an address/data bus or other communication mechanism for communicating information, which interconnects the devices and/or components of resource manager 102, such as processing device 402, network interface 406, input/output device 405, and device ID component 407.

In some embodiments, some or all of the devices and/or components of resource manager 102 may be implemented with the processing device 402. For example, the resource manager 102 may be implemented as a software application stored within the memory 404 and executed by the processing device 402. Accordingly, such embodiment can be implemented with minimal or no additional hardware costs. In some embodiments, any of these above-recited devices and/or components rely on dedicated hardware specifically configured for performing operations of the devices and/or components.

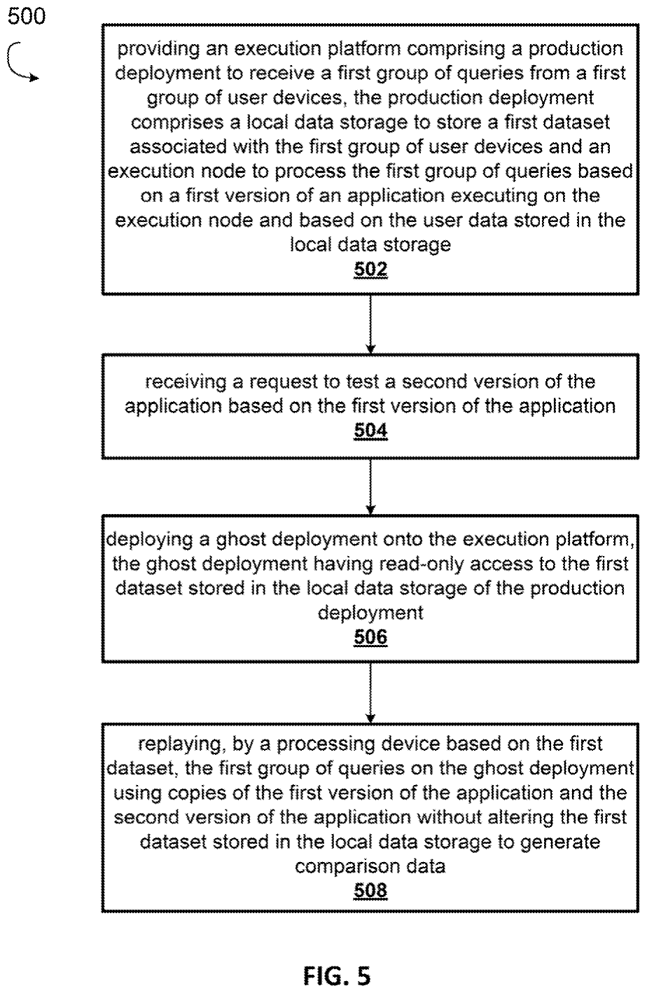

FIG. 5 is a flow diagram depicting a method of replaying queries, that originated on one or more deployments of an execution platform, on an isolated deployment to perform feature testing of a software application, according to some embodiments. Method 500 may be performed by processing logic that may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, one or more blocks of the method 500 may be performed by one or more resource managers, such as resource manager 102 in FIG. 3. In some embodiments, one or more blocks of the method 500 may be performed by one or more execution platforms, such as execution platform 312 in FIG. 3.

With reference to FIG. 5, method 500 illustrates example functions used by various embodiments. Although specific function blocks (“blocks”) are disclosed in method 500, such blocks are examples. That is, embodiments are well suited to performing various other blocks or variations of the blocks recited in method 500. It is appreciated that the blocks in method 500 may be performed in an order different than presented, and that not all of the blocks in method 500 may be performed.

As shown in FIG. 5, the method 500 includes the block 502 of providing an execution platform including a production deployment to receive a first group of queries from a first group of user devices, the production deployment includes a local data storage to store a first dataset associated with the first group of user devices and an execution node to process the first group of queries based on a first version of an application executing on the execution node and based on the user data stored in the local data storage. The method 500 includes the block 504 of receiving a request to test a second version of the application based on the first version of the application. The method 500 includes the block 506 of deploying a ghost deployment onto the execution platform, the ghost deployment having read-only access to the first dataset stored in the local data storage of the production deployment. The method 500 includes the block 508 of replaying, by a processing device based on the first dataset, the first group of queries on the ghost deployment using copies of the first version of the application and the second version of the application without altering the first dataset stored in the local data storage to generate comparison data.

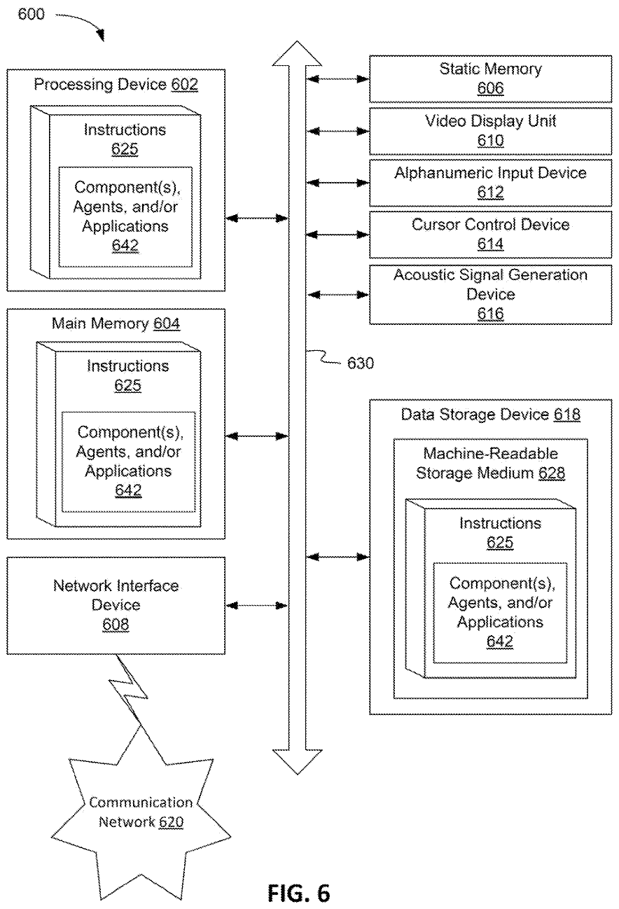

FIG. 6 is a block diagram of an example computing device 600 that may perform one or more of the operations described herein, in accordance with some embodiments. Computing device 600 may be connected to other computing devices in a LAN, an intranet, an extranet, and/or the Internet. The computing device may operate in the capacity of a server machine in a client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 600 may include a processing device (e.g., a general-purpose processor, a PLD, etc.) 602, a main memory 604 (e.g., synchronous dynamic random-access memory (DRAM), read-only memory (ROM)), a static memory 606 (e.g., flash memory and a data storage device 618), which may communicate with each other via a bus 630.

Processing device 602 may be provided by one or more general-purpose processing devices such as a microprocessor, central processing unit, or the like. In an illustrative example, processing device 602 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 602 may also include one or more special-purpose processing devices such as an application specific integrated circuit (ASIC), a field programmable gate array (FPGA), a digital signal processor (DSP), network processor, or the like. The processing device 602 may be configured to execute the operations described herein, in accordance with one or more aspects of the present disclosure, for performing the operations and steps discussed herein.

Computing device 600 may further include a network interface device 608 which may communicate with a communication network 620. The computing device 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In one embodiment, video display unit 610, alphanumeric input device 612, and cursor control device 614 may be combined into a single component or device (e.g., an LCD touch screen).

Data storage device 618 may include a computer-readable storage medium 628 on which may be stored one or more sets of instructions 625 that may include instructions for one or more components/agents/applications 642 (e.g., FTM agent 318 in FIG. 3, etc.) for carrying out the operations described herein, in accordance with one or more aspects of the present disclosure. Instructions 625 may also reside, completely or at least partially, within main memory 604 and/or within processing device 602 during execution thereof by computing device 600, main memory 604 and processing device 602 also constituting computer-readable media. The instructions 625 may further be transmitted or received over a communication network 620 via network interface device 608.

While computer-readable storage medium 628 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

### Examples

The following examples pertain to further embodiments:

Example 1 is a method. The method includes providing an execution platform including a production deployment to receive a first group of queries from a first group of user devices, the production deployment includes a local data storage to store a first dataset associated with the first group of user devices and an execution node to process the first group of queries based on a first version of an application executing on the execution node and based on the user data stored in the local data storage; receiving a request to test a second version of the application based on the first version of the application; deploying a ghost deployment onto the execution platform, the ghost deployment having read-only access to the first dataset stored in the local data storage of the production deployment; and replaying, by a processing device, the first group of queries on the ghost deployment using copies of the first version of the application and the second version of the application without altering the first dataset stored in the local data storage to generate comparison data.

Example 2 is a method as in Example 1, further including acquiring metadata indicating that the production deployment executed the first group of queries based on the first dataset stored in the local data storage of the production deployment; and wherein generating the comparison data is further based on the metadata.

Example 3 is a method as in any of Examples 1-2, further including reducing a visibility of the ghost deployment to prevent the first group of user devices and the production deployment from accessing the ghost deployment.

Example 4 is a method as in any of Examples 1-3, further including allocating, to the ghost deployment, an additional execution node of the execution platform to execute the copies of the first version of the application and the second version of the application using memory resources that are isolated from the production deployment.

Example 5 is a method as in any of Examples 1-4, further including determining, based on the comparison data, that a performance of the second version of the application is less than a performance of the first version of the application; and implementing a remedial action responsive to determining, based on the comparison data, that the performance of the second version of the application is less than the performance of the first version of the application.

Example 6 is a method as in any of Examples 1-5, wherein implementing the remedial action includes preventing a copy of the second version of the application from being installed on the production deployment.

Example 7 is a method as in any of Examples 1-6, wherein implementing the remedial action includes modifying the second version of the application based on the performance difference to generate a modified second version of the application; and deploying the modified second version of the application into the execution platform to cause the modified second version of the application to be installed on the production deployment.

Example 8 is a method as in any of Examples 1-7, further including determining that a performance of the modified second version of the application is greater than the performance of the first version of the application.

Example 9 is a method as in any of Examples 1-8, wherein the execution platform further includes a second production deployment to receive a second group of queries from a different user device, the second production deployment includes a second local data storage to store a second dataset and a second execution node to process the second group of queries based on the first version of the application executing on the second execution node and based on the second dataset stored in the second local data storage, and further including replaying the second group of queries on the ghost deployment using the copies of the first version of the application and the second version of the application without altering the second dataset stored in the local data storage to generate second comparison data.

Example 10 is a method as in any of Examples 1-9, wherein determining, based on the comparison data, that the performance of the second version of the application is less than the performance of the first version of the application is further based on the second comparison data.

Example 11 is a system. The system includes a memory; and a processing device, operatively coupled to the memory, to provide an execution platform including a production deployment to receive a first group of queries from a first group of user devices, the production deployment includes a local data storage to store a first dataset associated with the first group of user devices and an execution node to process the first group of queries based on a first version of an application executing on the execution node and based on the first dataset stored in the local data storage; receive a request to test a second version of the application based on the first version of the application; deploy a ghost deployment onto the execution platform, the ghost deployment having read-only access to the first dataset stored in the local data storage of the production deployment; and replay the first group of queries on the ghost deployment using copies of the first version of the application and the second version of the application without altering the first dataset stored in the local data storage to generate comparison data.

Example 12 is a system as in Example 11, wherein the processing device is further to acquire metadata indicating that the production deployment executed the first group of queries based on the first dataset stored in the local data storage of the production deployment; and wherein to generate the comparison data is further based on the metadata.

Example 13 is a system as in any of Examples 11-12, wherein the processing device is further to reduce a visibility of the ghost deployment to prevent the first group of user devices and the production deployment from accessing the ghost deployment.

Example 14 is a system as in any of Examples 11-13, wherein the processing device is further to allocate, to the ghost deployment, an additional execution node of the execution platform to execute the copies of the first version of the application and the second version of the application using memory resources that are isolated from the production deployment.

Example 15 is a system as in any of Examples 11-14, wherein the processing device is further to determine, based on the comparison data, that a performance of the second version of the application is less than a performance of the first version of the application; and implement a remedial action responsive to determining, based on the comparison data, that the performance of the second version of the application is less than the performance of the first version of the application.

Example 16 is a system as in any of Examples 11-15, wherein to implement the remedial action, the processing device is further to prevent a copy of the second version of the application from being installed on the production deployment.

Example 17 is a system as in any of Examples 11-16, wherein to implement the remedial action, the processing device is further to modify the second version of the application based on the performance difference to generate a modified second version of the application; and deploy the modified second version of the application into the execution platform to cause the modified second version of the application to be installed on the production deployment.

Example 18 is a system as in any of Examples 11-17, wherein the processing device is further to determine that a performance of the modified second version of the application is greater than the performance of the first version of the application.

Example 19 is a system as in any of Examples 11-18, wherein the execution platform further includes a second production deployment to receive a second group of queries from a different user device, the second production deployment includes a second local data storage to store a second dataset and a second execution node to process the second group of queries based on the first version of the application executing on the second execution node and based on the second dataset stored in the second local data storage, and wherein the processing device is further to replay the second group of queries on the ghost deployment using the copies of the first version of the application and the second version of the application without altering the second dataset stored in the local data storage to generate second comparison data.

Example 20 is a system as in any of Examples 11-19, wherein to determine, based on the comparison data, that the performance of the second version of the application is less than the performance of the first version of the application is further based on the second comparison data.

Example 21 is a non-transitory computer-readable medium storing instructions that, when execute by a processing device of a system, cause the processing device to provide an execution platform including a production deployment to receive a first group of queries from a first group of user devices, the production deployment includes a local data storage to store a first dataset associated with the first group of user devices and an execution node to process the first group of queries based on a first version of an application executing on the execution node and based on the first dataset stored in the local data storage; receive a request to test a second version of the application based on the first version of the application; deploy a ghost deployment onto the execution platform, the ghost deployment having read-only access to the first dataset stored in the local data storage of the production deployment; and replay, by the processing device, the first group of queries on the ghost deployment using copies of the first version of the application and the second version of the application without altering the first dataset stored in the local data storage to generate comparison data.

Example 22 is a non-transitory computer-readable medium as in Example 21, wherein the instructions, when executed by a processing device, further cause the processing device to acquire metadata indicating that the production deployment executed the first group of queries based on the first dataset stored in the local data storage of the production deployment; and wherein to generate the comparison data is further based on the metadata.

Example 23 is a non-transitory computer-readable medium as in any of Examples 21-22, wherein the instructions, when executed by a processing device, further cause the processing device to reduce a visibility of the ghost deployment to prevent the first group of user devices and the production deployment from accessing the ghost deployment.

Example 24 is a non-transitory computer-readable medium as in any of Examples 21-23, wherein the instructions, when executed by a processing device, further cause the processing device to allocate, to the ghost deployment, an additional execution node of the execution platform to execute the copies of the first version of the application and the second version of the application using memory resources that are isolated from the production deployment.

Example 25 is a non-transitory computer-readable medium as in any of Examples 21-24, wherein the instructions, when executed by a processing device, further cause the processing device to determine, based on the comparison data, that a performance of the second version of the application is less than a performance of the first version of the application; and implement a remedial action responsive to determining, based on the comparison data, that the performance of the second version of the application is less than the performance of the first version of the application.

Example 26 is a non-transitory computer-readable medium as in any of Examples 21-25, wherein the instructions, when executed by a processing device, further cause the processing device to prevent a copy of the second version of the application from being installed on the production deployment.

Example 27 is a non-transitory computer-readable medium as in any of Examples 21-26, wherein the instructions, when executed by a processing device, further cause the processing device to modify the second version of the application based on the performance difference to generate a modified second version of the application; and deploy the modified second version of the application into the execution platform to cause the modified second version of the application to be installed on the production deployment.

Example 28 is a non-transitory computer-readable medium as in any of Examples 21-27, wherein the instructions, when executed by a processing device, further cause the processing device to determine that a performance of the modified second version of the application is greater than the performance of the first version of the application.

Example 29 is a non-transitory computer-readable medium as in any of Examples 21-28, wherein the execution platform further includes a second production deployment to receive a second group of queries from a different user device, the second production deployment includes a second local data storage to store a second dataset and a second execution node to process the second group of queries based on the first version of the application executing on the second execution node and based on the second dataset stored in the second local data storage, and wherein the instructions, when executed by the processing device, further cause the processing device to replay the second group of queries on the ghost deployment using the copies of the first version of the application and the second version of the application without altering the second dataset stored in the local data storage to generate second comparison data.

Example 30 is a non-transitory computer-readable medium as in any of Examples 21-29, wherein to determine, based on the comparison data, that the performance of the second version of the application is less than the performance of the first version of the application is further based on the second comparison data.

Unless specifically stated otherwise, terms such as “providing,” “receiving,” “deploying,” “replaying,” “acquiring,” “generating,” “reducing,” “determining,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may include a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present embodiments to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present embodiments are not to be limited to the details given herein, but may be modified within the scope and equivalents of the appended claims.

What is claimed is:

1. A method comprising:
providing an execution platform comprising a production deployment to receive a first group of queries from a first group of user devices, the production deployment comprises a local data storage to store a first dataset associated with the first group of user devices and an execution node to process the first group of queries based on a first version of an application executing on the execution node and based on the user data stored in the local data storage;
receiving a request to test a second version of the application based on the first version of the application;
deploying a ghost deployment onto the execution platform, the ghost deployment having read-only access to the first dataset stored in the local data storage of the production deployment; and
replaying, by a processing device based on the first dataset, the first group of queries on the ghost deployment using copies of the first version of the application and the second version of the application without altering the first dataset stored in the local data storage to generate comparison data.

2. The method of claim 1, further comprising:
acquiring metadata indicating that the production deployment executed the first group of queries based on the first dataset stored in the local data storage of the production deployment; and
wherein generating the comparison data is further based on the metadata.

3. The method of claim 1, further comprising:
reducing a visibility of the ghost deployment to prevent the first group of user devices and the production deployment from accessing the ghost deployment.

4. The method of claim 1, further comprising:
allocating, to the ghost deployment, an additional execution node of the execution platform to execute the copies of the first version of the application and the second version of the application using memory resources that are isolated from the production deployment.

5. The method of claim 1, further comprising:
determining, based on the comparison data, that a performance of the second version of the application is less than a performance of the first version of the application; and
implementing a remedial action responsive to determining, based on the comparison data, that the performance of the second version of the application is less than the performance of the first version of the application.

6. The method of claim 5, wherein implementing the remedial action comprises:
preventing a copy of the second version of the application from being installed on the production deployment.

7. The method of claim 5, wherein the implementing the remedial action comprises:
modifying the second version of the application based on the performance difference to generate a modified second version of the application; and
deploying the modified second version of the application into the execution platform to cause the modified second version of the application to be installed on the production deployment.

8. The method of claim 7, further comprising:
determining that a performance of the modified second version of the application is greater than the performance of the first version of the application.

9. The method of claim 5, wherein the execution platform further comprises a second production deployment to receive a second group of queries from a different user device, the second production deployment comprises a second local data storage to store a second dataset and a second execution node to process the second group of queries based on the first version of the application executing on the second execution node and based on the second dataset stored in the second local data storage, and further comprising:
replaying the second group of queries on the ghost deployment using the copies of the first version of the application and the second version of the application without altering the second dataset stored in the local data storage to generate second comparison data.

10. The method of claim 9, wherein determining, based on the comparison data, that the performance of the second version of the application is less than the performance of the first version of the application is further based on the second comparison data.

11. A system comprising:
a memory; and
a processing device, operatively coupled to the memory, to:
provide an execution platform comprising a production deployment to receive a first group of queries from a first group of user devices, the production deployment comprises a local data storage to store a first dataset associated with the first group of user devices and an execution node to process the first group of queries based on a first version of an application executing on the execution node and based on the first dataset stored in the local data storage;
receive a request to test a second version of the application based on the first version of the application;
deploy a ghost deployment onto the execution platform, the ghost deployment having read-only access to the first dataset stored in the local data storage of the production deployment; and
replay, based on the first dataset, the first group of queries on the ghost deployment using copies of the first version of the application and the second version of the application without altering the first dataset stored in the local data storage to generate comparison data.

12. The system of claim 11, wherein the processing device is further to:
acquire metadata indicating that the production deployment executed the first group of queries based on the first dataset stored in the local data storage of the production deployment; and
wherein to generate the comparison data is further based on the metadata.

13. The system of claim 11, wherein the processing device is further to:
reduce a visibility of the ghost deployment to prevent the first group of user devices and the production deployment from accessing the ghost deployment.

14. The system of claim 11, wherein the processing device is further to:
allocate, to the ghost deployment, an additional execution node of the execution platform to execute the copies of the first version of the application and the second version of the application using memory resources that are isolated from the production deployment.

15. The system of claim 11, wherein the processing device is further to:
determine, based on the comparison data, that a performance of the second version of the application is less than a performance of the first version of the application; and
implement a remedial action responsive to determining, based on the comparison data, that the performance of the second version of the application is less than the performance of the first version of the application.

16. The system of claim 15, wherein to implement the remedial action, the processing device is further to:
prevent a copy of the second version of the application from being installed on the production deployment.

17. The system of claim 15, wherein to implement the remedial action, the processing device is further to:
modify the second version of the application based on the performance difference to generate a modified second version of the application; and
deploy the modified second version of the application into the execution platform to cause the modified second version of the application to be installed on the production deployment.

18. The system of claim 17, wherein the processing device is further to:
determine that a performance of the modified second version of the application is greater than the performance of the first version of the application.

19. The system of claim 15, wherein the execution platform further comprises a second production deployment to receive a second group of queries from a different user device, the second production deployment comprises a second local data storage to store a second dataset and a second execution node to process the second group of queries based on the first version of the application executing on the second execution node and based on the second dataset stored in the second local data storage, and wherein the processing device is further to:
replay the second group of queries on the ghost deployment using the copies of the first version of the application and the second version of the application without altering the second dataset stored in the local data storage to generate second comparison data.

20. The system of claim 19, wherein to determine, based on the comparison data, that the performance of the second version of the application is less than the performance of the first version of the application is further based on the second comparison data.

21. A non-transitory computer-readable medium storing instructions that, when execute by a processing device, cause the processing device to:
provide an execution platform comprising a production deployment to receive a first group of queries from a first group of user devices, the production deployment comprises a local data storage to store a first dataset associated with the first group of user devices and an execution node to process the first group of queries based on a first version of an application executing on the execution node and based on the first dataset stored in the local data storage;
receive a request to test a second version of the application based on the first version of the application;
deploy a ghost deployment onto the execution platform, the ghost deployment having read-only access to the first dataset stored in the local data storage of the production deployment; and
replay, by the processing device based on the first dataset, the first group of queries on the ghost deployment using copies of the first version of the application and the second version of the application without altering the first dataset stored in the local data storage to generate comparison data.

22. The non-transitory computer-readable medium of claim 21, wherein the instructions, when executed by the processing device, further cause the processing device to:
acquire metadata indicating that the production deployment executed the first group of queries based on the first dataset stored in the local data storage of the production deployment; and
wherein to generate the comparison data is further based on the metadata.

23. The non-transitory computer-readable medium of claim 21, wherein the instructions, when executed by the processing device, further cause the processing device to:
reduce a visibility of the ghost deployment to prevent the first group of user devices and the production deployment from accessing the ghost deployment.

24. The non-transitory computer-readable medium of claim 21, wherein the instructions, when executed by the processing device, further cause the processing device to:
allocate, to the ghost deployment, an additional execution node of the execution platform to execute the copies of the first version of the application and the second version of the application using memory resources that are isolated from the production deployment.

25. The non-transitory computer-readable medium of claim 21, wherein the instructions, when executed by the processing device, further cause the processing device to:
determine, based on the comparison data, that a performance of the second version of the application is less than a performance of the first version of the application; and
implement a remedial action responsive to determining, based on the comparison data, that the performance of the second version of the application is less than the performance of the first version of the application.

26. The non-transitory computer-readable medium of claim 25, wherein the instructions, when executed by the processing device, further cause the processing device to:
prevent a copy of the second version of the application from being installed on the production deployment.

27. The non-transitory computer-readable medium of claim 25, wherein the instructions, when executed by the processing device, further cause the processing device to:
modify the second version of the application based on the performance difference to generate a modified second version of the application; and
deploy the modified second version of the application into the execution platform to cause the modified second version of the application to be installed on the production deployment.

28. The non-transitory computer-readable medium of claim 27, wherein the instructions, when executed by the processing device, further cause the processing device to:
determine that a performance of the modified second version of the application is greater than the performance of the first version of the application.

29. The non-transitory computer-readable medium of claim 25, wherein the execution platform further includes a second production deployment to receive a second group of queries from a different user device, the second production deployment includes a second local data storage to store a second dataset and a second execution node to process the second group of queries based on the first version of the application executing on the second execution node and based on the second dataset stored in the second local data storage, and wherein the instructions, when executed by the processing device, further cause the processing device to:
replay the second group of queries on the ghost deployment using the copies of the first version of the application and the second version of the application without altering the second dataset stored in the local data storage to generate second comparison data.

30. The non-transitory computer-readable medium of claim 29, wherein to determine, based on the comparison data, that the performance of the second version of the application is less than the performance of the first version of the application is further based on the second comparison data.
